(19) United States
(12) Patent Application Publication
(10) Pub. No.: US 2019/0203784 A1
(43) Pub. Date: Jul. 4, 2019

(54) DISC BRAKE ROTOR HAVING A DAMPING ELEMENT

(71) Applicant: Lucas Automotive GmbH, Koblenz (DE)

(72) Inventors: Hans-Martin Giese, Polch (DE); Gerd Auer, Brachtendorf (DE); Nils Perzborn, Koblenz (DE); Udo Obel, Dachsenhausen (DE)

(73) Assignee: Lucas Automotive GmbH, Koblenz (DE)

(21) Appl. No.: 16/327,522

(22) PCT Filed: Jul. 26, 2017
(86) PCT No.: PCT/EP2017/068873

§ 371 Date: Feb. 22, 2019

(30) Foreign Application Priority Data
Aug. 24, 2016 (DE) 10 2016 010 300.0

(51) Int. Cl. F16D 55/22; F16D 65/00; F16D 65/12

(52) U.S. Cl. CPC F16D 55/22; F16D 65/12; F16D 65/0006

(57) ABSTRACT

A disc brake rotor for a disk brake assembly, which disk brake rotor comprises a friction ring having two annular friction surfaces, which are arranged opposite each other, which friction ring has an outer circumference and an inner circumference, and a disk brake rotor hat, which is designed to at least partly extend around a wheel bearing assembly of the vehicle. The disk brake rotor hat is connected to the friction ring in the region of the inner circumference of the friction ring and has an inner circumferential surface and an outer circumferential surface. At least one damping element is attached to the inner circumferential surface and/or to the outer circumferential surface of the disk brake rotor hat.

### CROSS-REFERENCE TO RELATED APPLICATIONS

This application is a national stage of International Application No. PCT/EP2017/068873, filed 26 Jul. 2017, the disclosures of which are incorporated herein by reference in entirety, and which claimed priority to German Patent Application No. 10 2016 010 300.0, filed 24 Aug. 2016, the disclosures of which are incorporated herein by reference in entirety.

### BACKGROUND TO THE INVENTION

There is described herein a brake disc for a disc brake arrangement, which brake disc comprises a friction ring and a brake disc pot. A disc brake arrangement for a vehicle is also described.

Many conventional disc brake arrangements for a vehicle are known from the prior art and comprise a disc brake as well as a brake disc having a friction ring and a brake disc pot connected thereto. The friction ring and the brake disc pot of the brake disc can be either in one piece or separate from one another. In a mounted state, the brake disc is connected in a rotationally secure manner to a vehicle wheel and rotates synchronously with the vehicle wheel while the vehicle is moving.

However, in the case of known disc brake arrangements, noise is frequently generated during operation, which can be perceived as troublesome by occupants of the vehicle. In particular, such noise can be caused by vibrations in the region of the brake disc, which vibrations are generated on initiation of a braking operation by contacting of brake pads with the brake disc and under certain circumstances have a frequency which corresponds to a resonance frequency of the brake disc.

In order to reduce such vibrations that occur during a braking operation and the noise resulting therefrom, known brake discs have structural adaptations of the friction ring and/or of the brake disc pot. The stiffness of the brake disc is thereby to be altered locally, which at the same time influences the natural frequencies of the brake disc.

Document KR 2008 0054198 A further proposes introducing a shim member between a wheel hub and a brake disc, which shim member has a rubber layer for damping vibrations that occur.

Furthermore, document EP 1 124 072 A2 discloses a multi-part brake disc having a friction ring and a brake disc pot, which brake disc has a damping means. The damping means is arranged in a coupling region between the friction ring and the brake disc pot, in which those components are coupled together. In addition, the damping material of the damping means has different degrees of damping distributed over the circumference.

Furthermore, document DE 101 25 115 A1 discloses a two-part brake disc which comprises a friction ring and a holding part connected thereto in an interlocking manner. The friction ring and the holding part are decoupled by a peripheral damping element which comprises a carrying ring and at least one annular damping material connected thereto. A plate spring-shaped securing ring secures the friction ring and the holding part against displacement in the axial direction.

Further prior art is known from document DE 101 25 114 A1, which discloses a brake disc having a friction ring and a holding part. At least one annular damping element is fixed to the friction ring and/or to the holding part, which damping element comprises a carrying ring and an annular damping material, the damping material being arranged without contact with the brake disc.

Despite known solutions, there is a continued need for an improvement to brake discs and disc brake arrangements in order to avoid the above-described vibrations and noise generation.

### SUMMARY OF THE INVENTION

Accordingly, a feature of the invention is to provide an improved brake disc and disc brake arrangement which reduce the occurrence of noise, in particular on initiation of a braking operation.

This feature is achieved by a brake disc for a disc brake arrangement which comprises a friction ring having two annular friction surfaces that are opposed to one another, which comprises an outer circumference and an inner circumference. In order to generate a braking action, the two friction surfaces can each be contactable by means of a brake pad of a disc brake. The brake disc comprises a brake disc pot which is configured to at least partially encompass a wheel bearing arrangement of the vehicle. The brake disc pot is connected to the friction ring in the vicinity of its inner circumference, in particular in a coupling region between the brake disc pot and the friction ring. The brake disc pot has an inner circumferential surface and an outer circumferential surface. At least one damping element is attached to the inner circumferential surface and/or to the outer circumferential surface of the brake disc pot.

In particular, the at least one damping element can be attached to the inner circumferential surface and/or the outer circumferential surface of a lateral surface of the brake disc pot. Furthermore, the at least one damping element can be adapted at least in part to the shape of the inner circumferential surface and/or the outer circumferential surface of the brake disc pot, or of the lateral surface of the brake disc pot. The brake disc pot and the friction ring can be coaxial with one another and have a common axis of rotation, that is to say the axis of rotation of the brake disc.

By attaching the at least one damping element to the inner circumferential surface and/or to the outer circumferential surface of the brake disc pot, the amplitudes of vibrations that occur and resulting sound pressure levels in that region can be reduced. The at least one damping means can thereby convert a kinetic and/or potential energy of the vibrations that occur, for example into heat energy. The at least one damping element thus has a damping effect on the vibrations that occur at the brake disc pot on initiation of and during a braking operation. In particular, the damping element can be so configured that it has a damping effect on specific vibration modes without substantially changing the natural frequencies of the brake disc. Troublesome noise generation in the region of the brake disc is thereby reduced by means of the at least one damping element. At the same time, the reduction of the amplitudes of vibrations that occur by the at least one damping element, in particular in the case of lightweight brake discs, which comprise, for example, an aluminium or sheet steel pot, prevents deformation occurring at the brake disc pot as a result of those vibrations.

The at least one damping element is attached to the inner circumferential surface and/or to the outer circumferential surface of the brake disc pot, that is to say to a free, or coupling-free, surface of the brake disc pot, and accordingly not in a coupling region between the brake disc pot and the friction ring. In contrast to known brake discs with damping means in such a coupling region between the friction ring and the brake disc pot, the solution described herein permits comparatively simple assembly of the brake disc. In the described solution, the at least one damping element can be attached to the inner circumferential surface and/or the outer circumferential surface of the brake disc pot without thereby affecting the coupling between the brake disc pot and the friction ring. Structural advantages are additionally obtained thereby, since the coupling region itself can be of comparatively simple form. A possible structural weak point at the brake disc is also avoided with the described solution, since no damping element or damping means is formed in the braking torque-transmitting coupling region.

A further advantage of the described solution is that the at least one damping element can be so configured that the further properties of the brake disc, such as, for example, its strength properties, material fatigue properties, thermal properties, etc., are substantially unaffected by the attachment of the damping element to the inner circumferential surface and/or outer circumferential surface of the brake disc pot. The at least one damping element can thus be attached to the brake disc without other structural changes to the brake disc pot and/or to the friction ring. Retrofitting of damping element-free brake discs with a damping element is thus also possible.

It will be appreciated that a plurality of damping elements can be attached to the brake disc pot. For example, at least one damping element can be attached to the inner circumferential surface of the brake disc pot and at least one further damping element can be attached to the outer circumferential surface of the brake disc pot. The plurality of damping elements may correspond with one another or be different from one another in terms of their geometry, dimension and/or properties.

In a further development of the brake disc, a portion of the inner circumferential surface and/or of the outer circumferential surface of the brake disc pot to which the at least one damping element is attached can be axially spaced apart from the friction ring. In other words, the portion of the inner circumferential surface and/or of the outer circumferential surface of the brake disc pot to which the at least one damping element is attached can be spaced apart from a coupling region between the brake disc pot and the friction ring.

The at least one damping element can be attached to the inner circumferential surface and/or to the outer circumferential surface of the brake disc pot by means of a bonding layer. The bonding layer is thus arranged in this embodiment between the at least one damping element and the brake disc pot. In particular, the bonding layer can be an adhesive bonding layer, so that the at least one damping element is attached to the brake disc pot by means of an adhesive connection. Adhesive damping of the vibration amplitudes can additionally be achieved thereby, for example in that molecular strings of the adhesive bonding layer deform structurally during a vibration of the brake disc and thus generate damping. Instead of an adhesive bonding layer, an elastomer or other material, for example, can also be provided as the bonding layer.

The bonding layer can have a layer thickness of between 0.02 mm and 0.2 mm. In particular, the bonding layer can have a layer thickness of between 0.05 mm and 0.15 mm or between 0.08 mm and 0.12 mm. For example, the bonding layer can have a layer thickness of 0.1 mm. By the choice of a particular bonding layer, that is to say a particular material of the bonding layer, and an associated choice of a defined layer thickness of the bonding layer in respect of the properties and geometry of the brake disc, of the brake disc pot and/or of the associated at least one damping element, it is possible to ensure defined damping of specific vibration modes during operation of the brake disc.

In a further development of the brake disc, the at least one damping element can be a ring segment and/or a ring. The geometry and dimensions of the ring segment and/or of the ring can be configured in accordance with a portion of the inner circumferential surface and/or of the outer circumferential surface of the brake disc pot, or of the lateral surface of the brake disc pot, and correspond substantially thereto. It is thus possible to ensure that the at least one damping element is securely seated on the brake disc pot. In particular, when the at least one damping element is in the form of a ring, a press fit between the ring and the inner circumferential surface and/or the outer circumferential surface of the brake disc pot can be provided. It is thereby possible to generate damping by friction by means of relative movements that occur during a vibration between the damping element, that is to say the ring, and the vibrating brake disc. The press fit must permit such a relative movement and must therefore not exceed a defined limit value above which the relative movement is suppressed by excessive frictional force. Alternatively, a bonding layer provided between the at least one damping element and the inner circumferential surface and/or the outer circumferential surface of the brake disc pot can be taken into consideration when configuring the at least one damping element in the form of the ring segment and/or of the ring. Where a plurality of damping elements are configured in the form of ring segments, they can be attached to the inner circumferential surface and/or the outer circumferential surface of the brake disc pot uniformly distributed thereon, for example. The plurality of ring segments can each have geometries and dimensions which are the same as or differ from one another.

The at least one damping element can further be formed from a metal, a plastics material or a fiber composite. In particular, the at least one damping element can be formed from a steel sheet. The material used for the at least one damping element can be chosen having regard to the properties of the brake disc and having regard to a bonding layer for attaching the ring segment and/or ring to the brake disc pot.

The at least one damping element can have a material thickness of between 0.4 mm and 2 mm, in particular between 0.6 mm and 1.4 mm. For example, the at least one damping element can have a material thickness of between 0.7 mm and 1.1 mm. By the choice of at least one specific damping element, that is to say a specific material of the at least one damping element, and an associated choice of a defined material thickness of the at least one damping element in respect of the properties and geometry of the brake disc, of the brake disc pot and/or of the associated bonding layer, it is possible to ensure defined damping of specific vibration modes during operation of the brake disc.

In one embodiment, the described brake disc can be in one piece. The friction ring is thereby formed in one piece with the brake disc pot.

Alternatively, in a further embodiment the described brake disc can be in multi-part form. In this further embodiment, the friction ring and the brake disc pot can be separate from one another. The brake disc can thereby be of lightweight construction, for example with a brake disc pot produced from a light metal.

In the case of a multi-part brake disc, the brake disc pot can have at least one coupling means which, in a coupling region of the brake disc pot, is coupled in a rotationally secure manner with at least one complementary coupling means of the friction ring. The at least one coupling means can extend beyond the coupling region in which the coupling between the friction ring and the brake disc pot is formed. The coupling means can accordingly also be formed at least in part in a coupling-free portion of the inner circumferential surface and/or of the outer circumferential surface of the brake disc pot. The at least one coupling means can have a tooth system, for example. Any other interlocking or friction-based, rotationally secure coupling between the friction ring and the brake disk pot can also be formed, for example in the form of a tongue and groove connection or the like.

According to a further development of the brake disc, the at least one damping element can be attached to the inner circumferential surface and/or to the outer circumferential surface of the brake disc pot in the region of the at least one coupling means. The at least one damping element can thereby be attached to a free, or coupling-free, portion of the at least one coupling element that is axially spaced apart from the coupling region of the brake disc pot. Where the coupling means is in the form of a tooth system, the at least one damping element can be attached, for example, solely or substantially in the region of the tips of the teeth of the coupling means, whereby the tips of the teeth do not contact the complementary coupling means of the friction ring.

A bonding layer can be arranged between the coupling means and the at least one damping element in order to fixedly connect the coupling means to the at least one damping element.

A further aspect relates to a disc brake arrangement for a vehicle. The disc brake arrangement comprises a brake carrier, a brake caliper attached to the brake carrier, and two brake pad arrangements which are displaceable by means of the brake caliper and each have a brake pad carrier and a brake pad. The disc brake arrangement further comprises a brake disc of the above-described type arranged between the two brake pad arrangements, which brake disc is rotatable about an axis of rotation of the brake disc. The brake disc comprises at least one damping element which is attached to an inner circumferential surface and/or to an outer circumferential surface of a brake disc pot of the brake disc.

It will be appreciated that the disclosed subject-matter is not limited to the further developments and embodiments described above. In fact, it will be apparent to the person skilled in the art that the aspects and features described above can be combined as desired without departing from the subject-matter of the invention.

Further features, advantages and possible applications will become apparent from the following description of exemplary embodiments which are not to be interpreted as limiting and make reference to the accompanying schematic drawings. In the drawings, all the features which are described and/or depicted show the subject-matter disclosed herein on their own or in any desired combination. The dimensions and proportions of the components shown in the figures are not necessarily to scale.

### BRIEF DESCRIPTION OF THE DRAWINGS

FIG. 1 is a perspective view of a brake disc according to a first embodiment.

FIG. 2 is a perspective sectional view of a detail of the brake disc according to FIG. 1.

FIG. 3 is a perspective sectional view of a detail of a brake disc according to a second embodiment.

FIG. 4 is a perspective view of a brake disc pot for a multi-part brake disc.

FIG. 5 is a perspective view of a brake disc pot for a multi-part brake disc according to a third embodiment.

FIG. 6 is a perspective sectional view of a detail of a brake disc pot for a multi-part brake disc according to a fourth embodiment.

### DETAILED DESCRIPTION OF THE INVENTION

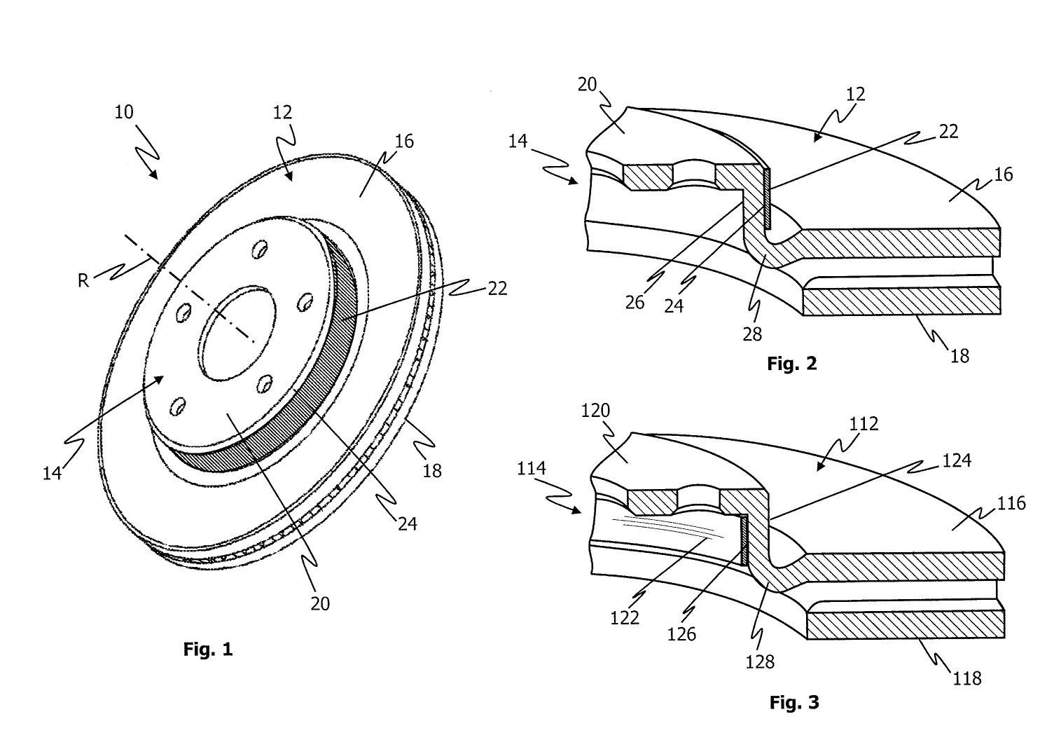

FIG. 1 shows a brake disc 10 according to a first embodiment, which comprises a friction ring 12 having an outer circumference and an inner circumference, as well as a brake disc pot 14. The brake disc pot 14 adjoins the friction ring 12 in the region of the inner circumference. The friction ring 12 and the brake disc pot 14 are in one piece in the embodiment shown and are arranged coaxially with one another. In a state (not shown here) in which it is fixed to a vehicle, the brake disc 10 is rotatable together with an associated vehicle wheel about an axis of rotation R.

The friction ring 12 comprises a first annular friction surface 16 and a second annular friction surface 18 axially opposed thereto, which friction surfaces are each contactable by means of a brake pad of the disc brake (not shown) in order to generate a braking action. The brake disc pot 14 comprises an end face 20 which is parallel to the friction ring 12, that is to say to the friction surfaces 16, 18 of the friction ring 12, and axially spaced apart therefrom. Starting from the end face 20, a lateral surface of the brake disc pot 14 extends axially in the direction towards the friction ring 12. The brake disc pot 14 is configured to encompass a wheel bearing arrangement (not shown) of the vehicle.

As can be seen in FIG. 1, the brake disc 10 has a damping element 22 which in the first embodiment shown is in the form of sheet steel ring and is attached to an outer circumferential surface 24 of the brake disc pot 14. This sheet steel ring 22 reduces the amplitude of vibrations that occur during operation of the brake disc 10 on actuation of the brake. The sheet steel ring 22 thus reduces sound pressure levels resulting from those vibrations and reduces noise generation in the region of the brake disc 10. By damping the vibrations that occur, the sheet steel ring 22 additionally prevents deformation of the brake disc pot 14, which can increase the service life of the brake discs.

Components and features which are comparable or the same and have the same action are in each case provided with the same reference numerals in the further figures relating to the same embodiment of the brake disc. With regard to further embodiments of the brake disc, the same reference numerals as for the first embodiment are used for components and features which are comparable or the same and have the same action, but they are preceded by a consecutive number, starting at 1. Components and features that are not described again in relation to the further figures have the same configuration and function as the corresponding components and features according to the other figures.

FIG. 2 is a sectional view of a detail of the brake disc 10 shown in FIG. 1. In this sectional view, an inner circumferential surface 26 of the lateral surface of the brake disc pot 14 can also be seen, to which a damping element is not attached according to the first embodiment. The lateral surface of the brake disc pot 14 is connected in one piece to the friction ring 12 in the region of the inner circumference of the friction ring 12 via the arcuate connecting portion 28.

In FIG. 2, the damping element 22 is attached to the outer circumferential surface 24 of the brake disc pot 14 by means of a press fit, without a bonding layer being applied between the damping element 22 and the outer circumferential surface 24. However, it will be appreciated that a bonding layer can be provided between the damping element and the brake disc pot in further embodiments of the brake disc. This bonding layer can additionally effect a reduction in the amplitudes of vibrations that occur and thus enhance and improve the above-described technical effects of the sheet steel ring 22. It is also possible in further embodiments to use other materials for the damping element instead of a steel sheet.

FIG. 3 is a perspective sectional view of a detail of a brake disc according to a second embodiment. In contrast to the first embodiment shown in FIGS. 1 and 2, the damping element 122 in the second embodiment shown in FIG. 3 is attached to the inner circumferential surface 126 of the brake disc pot 114. In the second embodiment too, the damping element 122 is in the form of a sheet steel ring. This sheet steel ring 122 is adapted in terms of its geometry to the inner circumferential surface 126 of the brake disc pot 114, so that there is a press fit between the sheet steel ring 122 and the inner circumferential surface 126.

A bonding layer between the sheet steel ring 122 and the inner circumferential surface 126 of the brake disc pot 114 is not provided in the example shown in FIG. 2. However, it will be appreciated that adhesive attachment of the damping element to the inner circumferential surface of the brake disc pot by means of a bonding layer is possible in further embodiments of the brake disc. It is also possible in further embodiments to use other materials for the damping element instead of a steel sheet.

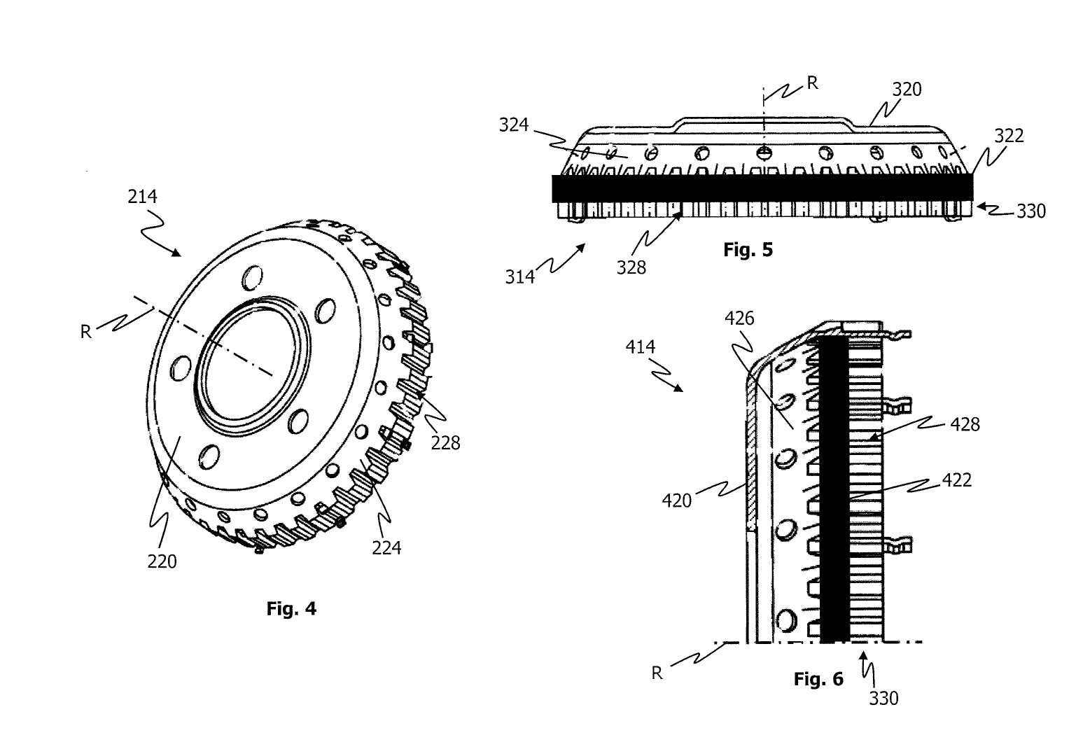

FIG. 4 is a perspective view of a brake disc pot 214 for a multi-part brake disc. In order to be able to couple the brake disc pot 214 in a rotationally secure manner with an associated friction ring (not shown), the brake disc pot 214 has a coupling means 228 formed on the lateral surface of the brake disc pot 214. In the example shown, the coupling means 228 is in the form of a tooth system in the lateral surface of the brake disc pot 214. The tooth system 228 thereby forms an external tooth system on the outer circumferential surface 224 and an internal tooth system on the inner circumferential surface (see FIG. 6) of the brake disc pot 214. The coupling means 228 is configured to be coupled in an interlocking manner with a complementary coupling means (not shown) of the associated friction ring.

FIG. 5 shows a brake disc pot 314 of a third embodiment of a brake disc. This brake disc pot 314 corresponds substantially to the brake disc pot 214 for a multi-part brake disc shown in FIG. 4. However, the brake disc pot 314 according to FIG. 5 has a damping element 322 attached to the outer circumferential surface 324 of the brake disc pot 314.

In the embodiment shown, the damping element 322 is a sheet steel ring which is configured on its inner circumferential surface to be substantially complementary to the outer circumferential surface of the coupling means 328 of the brake disc pot 314. It will be appreciated that, in another embodiment, a damping element that does not have a complementary configuration to the coupling means can also be attached to the lateral surface of the brake disc pot having the coupling means.

As can be seen in FIG. 5, the sheet steel ring 322 is arranged on the outer circumferential surface 324 of the brake disc pot 314 in a region of the coupling means 328 which, when the brake disc pot 314 and an associated friction ring are joined together, does not contact the friction ring in a load-transmitting manner, that is to say remains coupling-free. A coupling between the brake disc pot 314 and the associated friction ring—between the coupling means 328 and the complementary coupling means is provided only in a coupling region 330 of the coupling means 328. This coupling region 330 extends in the embodiment shown, starting from an end of the lateral surface of the brake disc pot 314 that is opposite the end face 320, in the direction towards the end face 320. By arranging the sheet steel ring 322 in the coupling-free region of the coupling means 328 in the region of the tips of the teeth, coupling between the brake disc pot 314 and the associated friction ring is not affected.

FIG. 6 is a sectional view of a detail of a brake disc pot 414 for a multi-part brake disc according to a fourth embodiment. The brake disc pot 414 corresponds substantially to the brake disc pots 214, 314 for a multi-part brake disc shown in FIGS. 4 and 5. In contrast to the brake disc pot 314 shown in FIG. 5, the brake disc pot 414 shown in FIG. 6 has a damping element 422 on the inner circumferential surface 426 of the brake disc pot 414. A damping element attached to the outer circumferential surface 424 according to FIG. 5 is not provided in the fourth embodiment according to FIG. 6.

In the embodiment shown, the damping element 422 is a sheet steel ring which is configured on its outer circumferential surface to be substantially complementary to the inner circumferential surface of the coupling means 428 of the brake disc pot 414. It will be appreciated that, in another embodiment, a damping element that does not have a complementary configuration to the coupling means can also be attached to the lateral surface of the brake disc pot having the coupling means.

It will further be appreciated that the exemplary embodiments described hereinbefore are not exhaustive and do not limit the subject-matter disclosed herein. In particular, it will be apparent to the person skilled in the art that he can combine the described features with one another as desired and/or omit various features without departing from the subject-matter disclosed herein.

Thus, for example, damping elements can be attached to the outer circumferential surface and to the inner circumferential surface of a brake disc pot—with or without coupling means. The damping elements can be attached to the brake disc pot by means of a bonding layer, a press fit and/or a configuration complementary to the corresponding lateral surface of the brake disc pot. It is also possible for a plurality of damping elements and/or bonding layers attached to a brake disc pot to have the same width and/or material thickness or different widths and/or material thicknesses. It is also possible for a plurality of damping elements and/or bonding layers attached to a brake disc pot to have the same materials or different materials.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A brake disc for a disc brake arrangement, comprising:
a friction ring having two annular friction surfaces that are opposed to one another, which comprises an outer circumference and an inner circumference, and
a brake disc pot which is configured to at least partially encompass a wheel bearing arrangement of a vehicle, wherein the brake disc pot is connected to the friction ring in the vicinity of an inner circumference thereof, and wherein the brake disc pot has an inner circumferential surface (26, 126, 426) and an outer circumferential surface,
wherein at least one damping element is attached to the inner circumferential surface and/or to the outer circumferential surface of the brake disc pot,
wherein a portion of the inner circumferential surface and/or of the outer circumferential surface of the brake disc pot to which the at least one damping element is attached is axially spaced apart from a coupling region between the brake disc pot and the friction ring.

2. The brake disc as claimed in claim 1, wherein the at least one damping element is attached to the inner circumferential surface and/or to the outer circumferential surface of the brake disc pot by means of a bonding layer.

3. The brake disc as claimed in claim 2, wherein the bonding layer has a layer thickness of between 0.02 mm and 0.2 mm.

4. The brake disc as claimed in claim 1, wherein the at least one damping element is a ring segment and/or a ring.

5. The brake disc as claimed in claim 4, that the at least one damping element is formed from a metal, a plastics material or a fiber composite, wherein the ring segment and/or the ring is formed from a steel sheet.

6. The brake disc as claimed in claim 1, that the at least one damping element has a material thickness of between 0.5 mm and 2 mm.

7. The brake disc as claimed in claim 1, wherein the friction ring is formed in one piece with the brake disc pot.

8. The brake disc as claimed in claim 1, wherein the friction ring and the brake disc pot are separate from one another.

9. The brake disc as claimed in claim 8, wherein the brake disc pot has at least one coupling means which, in the coupling region of the brake disc pot, is coupled in a rotationally secure manner with at least one complementary coupling means of the friction ring.

10. The brake disc as claimed in claim 9, wherein the at least one damping element is attached to a free portion of the at least one coupling means that is axially spaced apart from the coupling region of the brake disc pot.

11. A disc brake arrangement for a vehicle, having
a brake carrier,
a brake caliper attached to the brake carrier,
two brake pad arrangements which are displaceable by means of the brake caliper and each have a brake pad carrier and a brake pad, and
the brake disc as claimed in claim 1 arranged between the two brake pad arrangements, which brake disc is rotatable about an axis of rotation of the brake disc.

12. The brake disc as claimed in claim 1, wherein the at least one damping element is attached to the inner circumferential surface and/or to the outer circumferential surface of the brake disc pot by an adhesive bonding layer.

13. The brake disc as claimed in claim 2, wherein the bonding layer has a layer thickness of between 0.08 mm and 1.2 mm.

14. The brake disc as claimed in claim 1, that the at least one damping element has a material thickness of between 0.7 mm and 1.4 mm.

15. The brake disc as claimed in claim 9, wherein the at least one coupling means has a tooth system.
